(19) United States
(12) Patent Application Publication
(10) Pub. No.: US 2024/0372897 A1
(43) Pub. Date: Nov. 7, 2024

(54) DELAYED DATA DELIVERY INFORMATION IN LAWFUL INTERCEPTION

(71) Applicant: Telefonaktiebolaget LM Ericsson (publ), Stockholm (SE)

(72) Inventors: Tiziana BELLAVISTA, Gaeta (LT) (IT); Mario ASCIONE, Torre del Greco (NA) (IT); Domenico Raffaele CIONE, Caserta (IT)

(73) Assignee: Telefonaktiebolaget LM Ericsson (publ), Stockholm (SE)

(21) Appl. No.: 18/687,606

(22) PCT Filed: Aug. 30, 2021
(86) PCT No.: PCT/EP2021/073889

§ 371 Date: Feb. 28, 2024

(51) Int. Cl. H04L 9/40

(52) U.S. Cl. CPC H04L 63/30

(57) ABSTRACT

Method (500) and network devices (600, 700) in a communication service provider domain in which lawful interception is performed buffer LI data when a delivery process of the LI data to a law enforcement agency is interrupted. After the delivery process is restored, each of the buffered LI data is transmitted with corresponding delayed data delivery information to the law enforcement agency. Computer readable recording medium and a computer program are also disclosed.

### TECHNICAL FIELD

The embodiments described in this document generally relate to lawful interception (LI) in a communication system; more specifically, delayed data delivery information (DDDI) is provided with buffered LI data if delivery from a communication service provider (CSP) to a law enforcement agency (LEA) is delayed.

### BACKGROUND

Lawful interception (LI) is accomplished by hardware and software of communication system operators that selectively acquire and transmit communication service-related information of targeted subscriber(s) to law enforcement agencies, LEAs. Communication systems operators (called Communication Service Providers, CSPs) exchange packets/messages related to LI with LEA(s) via handover interfaces (HIs) that may be standardized. For example, LI HIs operating in internet protocol (IP) networks are specified in ETSI TS 102 232-1 V.3.21.1 entitled “Lawful Interception (LI); Handover Interface and Service-Specific Details (SSD) for IP delivery; Part 1: Handover specification for IP delivery” (made public in March 2021), ETSI TS 102 232-2 V.3.12.1 entitled “Lawful Interception (LI); Handover Interface and Service-Specific Details (SSD) for IP delivery; Part 2: Service-specific details for messaging services” (made public in August 2020), ETSI TS 102 232-3 V.3.9.1 entitled “Lawful Interception (LI); Handover Interface and Service-Specific Details (SSD) for IP delivery; Part 3: Service-specific details for internet access service” (made public in November 2020), ETSI TS 102 232-4 V3.4.1 entitled “Lawful Interception (LI); Handover Interface and Service-Specific Details (SSD) for IP delivery; Part 4: Service-specific details for Layer 2 services” (made public in August 2018), ETSI TS 102 232-5 V3.13.1 entitled “Lawful Interception (LI); Handover Interface and Service-Specific Details (SSD) for IP delivery; Part 5: Service-specific details for IP Multimedia services” (made public in October 2020), ETSI TS 102 232-6 V3.3.1 entitled “Lawful Interception (LI); Handover Interface and Service-Specific Details (SSD) for IP delivery; Part 6: Service-specific details for PSTN/ISDN services” (made public in March 2014), ETSI TS 102 232-7 V3.8.1 entitled “Lawful Interception (LI); Handover Interface and Service-Specific Details (SSD) for IP delivery; Part 7: Service-specific details for Mobile services” (made public in August 2020). LI data intercepted and transferred to LEA may be intercept-related information, IRI (i.e., call data including information about the targeted communications, destination, source, time of the call, duration, etc.) and communication content, CC (i.e., information exchanged between two or more users of a communications service of the CSP). In order to rapidly provide and deploy communication services, the CSPs may deploy service instances as software that runs on cloud infrastructure (i.e., software together with deployment instructions form virtual network functions, VNFs). As a cloud-type deployment is possible for both CSP and LEA functionality, it is more suggestive to discuss CSP and LEA domains that encompass multiple instances and overall functionality.

TS 102 232-1 describes the general aspects of the HI2 and HI3 interfaces between the CSP and the LEA domains (e.g., headers to be added to IRI and CC, protocols and protocol profiles for the handover interface). LI data related to a lawful intercept identifier, LIID, a communication intercept identifier, CID, and according to the payload type (i.e., IRI and/or CC) specified in the warrant received from LEA regarding a targeted subscriber is gathered in CSP domain. According to TS 102 232-1, two functions of CSP domain manage the intercepted data: one known as handover manager (HM) and another one named delivery function (DF).

FIG. 1 illustrates a conventional multi-DF LI data delivery from a CSP domain to an LEA domain. HM 110 manages intercepted LI data of all running LI instances, routing them to the appropriate destination(s). HM's default setting is to set up a single DF (e.g., 122, 124, 126) for each LI instance/process. It is then recommended, where multiple DFs are associated with one law enforcement monitoring facility, LEMF 150, that each DF point to a different intermediate destination, a so-called LEMF-Gateway (LGW) (i.e., 122 to 142, 124 to 144, 126 to 146). These gateways and the LEMF equipment pertain to the LEA domain. HM performs a mediation function distributing the data packages over the appropriate DF to LEMF-Gateway pair. LI data received from the CSP domain is then processed in the LEA domain.

Conventionally, one of the following two time-type pieces of information is notified from the CSP to the LEA domain when transmitting LI data packets on the handover network 130: (1) timeofinterception, which indicates when data was acquired at user equipment and/or network level, and (2) timeofmediation, which indicates time at HM level. In an arrangement such as in FIG. 1, each of the LI data delivery links (e.g., 122-142, 124-144 and 126-146 via the handover network 130) is required to process and manage respective LI data from CSP to LEA. Using a single delivery link with extended buffering for an extended processing at DF level saves multi-link processing, and it is the solution implemented by many LEAs.

TS 102 232-1 requires no LI data be lost due to unexpected termination of the transport connection and no traffic (i.e., LI data packets) be dropped during very short system outages. Therefore, the CSP's delivery function(s) must be able to buffer LI data. LI data is processed in the CSP domain quite fast, so there is not a significant difference between the LI data delivery time and the time of mediation or time of interception. However, the following scenarios have been identified recently to have a significant difference between the time of interception/mediation and the time of delivery: (1) when HM and DF have different locations, (2) when is DF out of service for any reason, and (3) when interruption in communication between CSP and LEA domains occurs.

Standard documents do not currently address these situations that are common in IP networks, but some local regulations (e.g., “Technical Guideline for implementing legal measures for telecommunications surveillance and information disclosure” published by Germany's Federal Network Agency for Electricity, Gas, Telecommunications, Post and Railway) require CSPs to maintain and buffer intercepted data until the LEA is available to receive it, with a buffer period configurable up to several hours. These circumstances are becoming more evident and frequent in cloud/5G networks where DF and HM could be dynamically allocated on demand. Currently, LEA equipment cannot detect a delayed delivery because CSP provides only information regarding the time of interception and the time of mediation on HI.

It is therefore desirable to address the above-identified conventional LI lack of information regarding delayed LI data delivery from CSP to LEA.

### SUMMARY

An object of the invention is to improve the usefulness or reliability of a lawful interception.

According to an embodiment, there is a method performed in a CSP domain in which a LI is executed. The method includes buffering intercepted LI data when a delivery process for transmitting the intercepted LI data to a law enforcement agency, LEA is interrupted. The method further includes transmitting each of the buffered LI data with corresponding DDDI to the LEA after the delivery process is restored.

According to another embodiment, there is a network device of a CSP performing LI. The network device has a network interface, a data processing unit and a memory cooperatively operating to buffer intercepted LI data when a delivery process transmitting the intercepted LI data to a LEA is interrupted, and to transmit each of the buffered LI data with corresponding DDI to the LEA after the delivery process is restored.

According to yet another embodiment, there is a network device of a CSP performing LI, the network device having a communication module, a storage unit, and a data delivery module. The communication module delivers intercepted LI data to a LEA. The storage unit stores the intercepted LI data when a delivery of the intercepted LI data to LEA is interrupted. The data delivery module provides DDDI to be delivered with each of the buffered intercepted LI data when the delivery is restored.

According to an embodiment, there is a computer readable recording medium non-transitorily storing executable codes which, when executed by a computer of a CSP performing LI make the computer to perform a method for providing DDDI to LEA.

According to yet another embodiment, there is a computer program which comprises instructions that when executed by a computer of a CSP performing LI, causes the computer to perform the method.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conventional multi-DF LI data delivery from a CSP domain to an LEA domain;

FIG. 2 illustrates multi-DF LI data delivery from CSP domain to LEA domain according to an embodiment;

FIG. 3 illustrates a scenario in which DF is replaced by DDDF according to an embodiment;

FIG. 4 illustrates DDDF in the 5G LI context according to an embodiment

FIG. 5 is a flowchart of a method according to an embodiment;

FIG. 6 is a diagram of a CSP device according to an embodiment; and

FIG. 7 is a schematic diagram of a CSP device according to another embodiment.

### DETAILED DESCRIPTION

The meanings of some abbreviations used in this document are explained below:
3GPP 3^{rd} Generation Partnership Project
5G 5^{th} generation of cellular mobile communications
ADMF Administration Function
CC Content of Communication
CID Communication Identifier
CSP Communication Service Provider
DF Distribution Function
DDDF Delayed Data Delivery Function
DDDI Delayed Data Delivery Information
ETSI European Telecommunications Standards Institute
HI1, HI2, HI3 Handover Interfaces
HM Handover Manager
IP Internet Protocol
IRI Intercept Related Information
LEA Law Enforcement Agency
LEMF Law Enforcement Monitoring Facility
LGW LEMF Gateway
LI Lawful Interception
LIID Lawful Intercept Identifier
MF Mediation Function
TS Technical Specification
VNF Virtual Network Function

The following description of the embodiments refers to the accompanying drawings. The same reference numbers in different drawings identify the same or similar elements. The following detailed description does not limit the invention. Instead, the scope of the invention is defined by the appended claims. Some of the embodiments are described in a standardized context (e.g., 5G), but such a context is not to be considered a limitation for the described approaches to LI implementation in communication systems. A “communication system” means hardware and software cooperatively interconnected to provide various network-based communication services.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

The embodiments described in this section make it possible for a CSP to supply delayed data delivery information (DDDI) to an LEA. The DDDI may include a parameter (e.g., named “timeofdelivey”) that specifies a time of the LI data delivery with which it is associated. Additionally or alternatively, the DDDI may include another parameter (e.g., named “delayofdelivery”) that specifies an amount of delay corresponding to the LI data delivery with which it is associated. These (and possible other) parameters are optionally transmitted via an HI2/HI3 interface modified for this purpose. Such additional information may be very relevant for investigating situations in which significant events occur during the delay interval.

According to an embodiment, CSPs include devices able to execute a new function, named “delayed data delivery function (DDDF)”. DDDF is considered a complete solution in a CSP domain from initiating a LI task by transmitting a warrant on HI1, continuing with specifying the manner of executing DDDF on X1 interface to MDF and finishing with transmitting DDDI with LI data on HI2/3 interfaces toward LEA. The solution is applicable to all standard networks including 5G as defined in 3GPP TS 33 127 V16.7.0 entitled “3rd Generation Partnership Project; Technical Specification Group Services and System Aspects; Security; Lawful Interception (LI) architecture and functions” (made public in April 2021), which refers to ETSI for the X and H interfaces definitions.

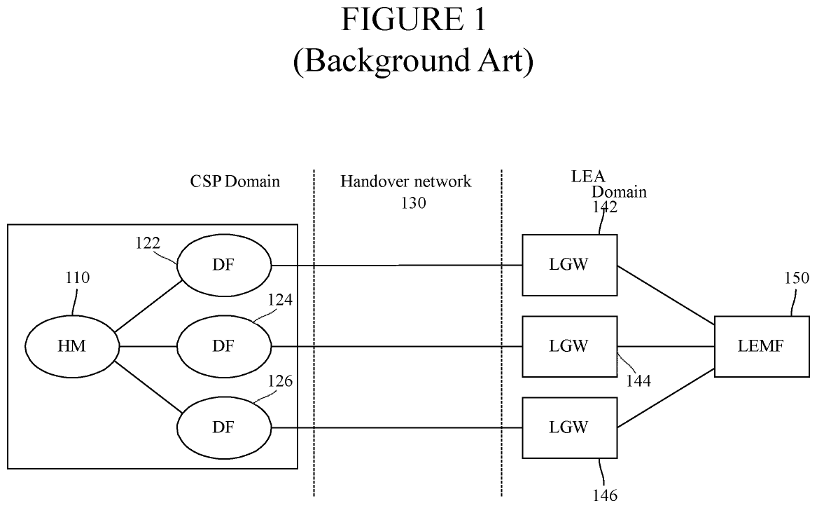

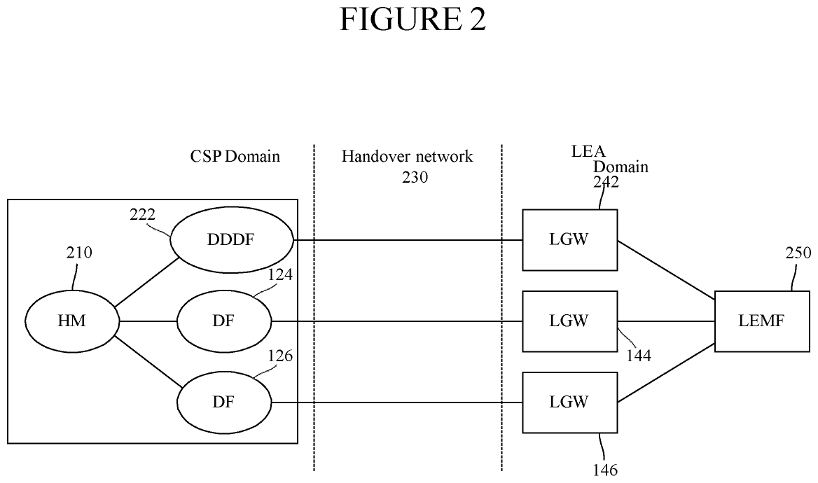

FIG. 2 illustrates multi-DF LI data delivery from CSP domain to LEA domain according to an embodiment. DDDF 222 replaces the standardized DF 122 in FIG. 1. HM 210 is able to handle DDDF 222 and trigger DDDF 222 replacing DF 122 from the beginning of an interception or when certain conditions are met, as later discussed. Handover network 230 now includes both standard interfaces HI2/HI3 connecting DF 124 to LGW 144 and DF 126 to LGW 146 and a modified HI2/HI3 able to carry DDDI in addition to LI data from DDDF 222 to LGW 242. LEMF 250 is able to receive and use DDDI arriving via LGW 242. It should be understood that more than one standardized DF may be replaced by DDDF(s), FIG. 2 being merely an illustration and not a limitation.

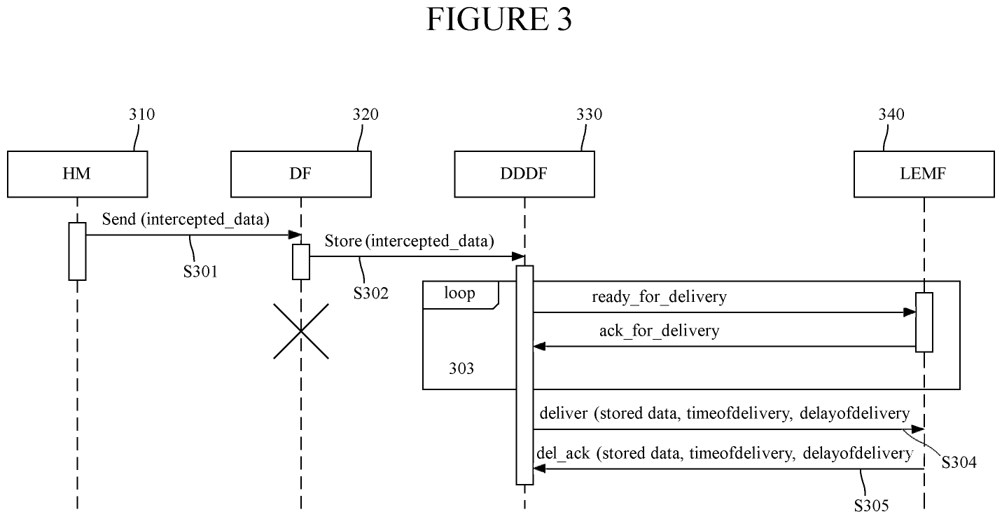

A scenario for DF replacing DDDF when an interruption in LI data delivery occurs is illustrated in FIG. 3. In this scenario, time flows from up down. HM 310 sends data to DF 320 at S301, which transmits the LI data promptly to LEMF 340 (this latter action is not explicitly illustrated). However, once an interruption of communication between CSP (DF) and LEA (LEMF) domains occurs, DDDF 330 takes over from DF 320. DF 320's deactivation is suggested by the cross on DF's timeline. DDDF 330 then stores (buffers) the undeliverable LI data at S302. DDDF 330 waits in loop 303 until the communication between CSP (DF) and LEA (LEMF) domains is restored. That is, DDDF 330 periodically sends a ready_for_delivery message until receiving an ack_for_delivery response from LEMF 340. Then, at S304, DDDF 330 starts transmitting the buffered LI data together with the DDDI (e.g., timeofdelivery and delayofdelivery parameters) to LEMF 340. At S305, LEMF 340 replies with a delivery acknowledgement to DDDF 330.

The manner of activating DDDF may be specified by LEA via the warrant initiating or modifying an LI task of a specific target. Activation may occur in cases where an LI transmission from CSP to LEA domain is delayed more than a predetermined time interval (e.g., 10s or 30s). Activation may occur if LI data buffering becomes necessary (i.e., interruption is longer than interval between two LI data interceptions). LEA may also request DDDF be active from the beginning of LI task. However, when there is no delay (e.g., once the buffered LI data is successfully transmitted to LEA domain, or prior to a communication interruption if DDDF is activated at LEA's demand), the DDDI parameters may have default values (e.g., zero values) indicating no delay.

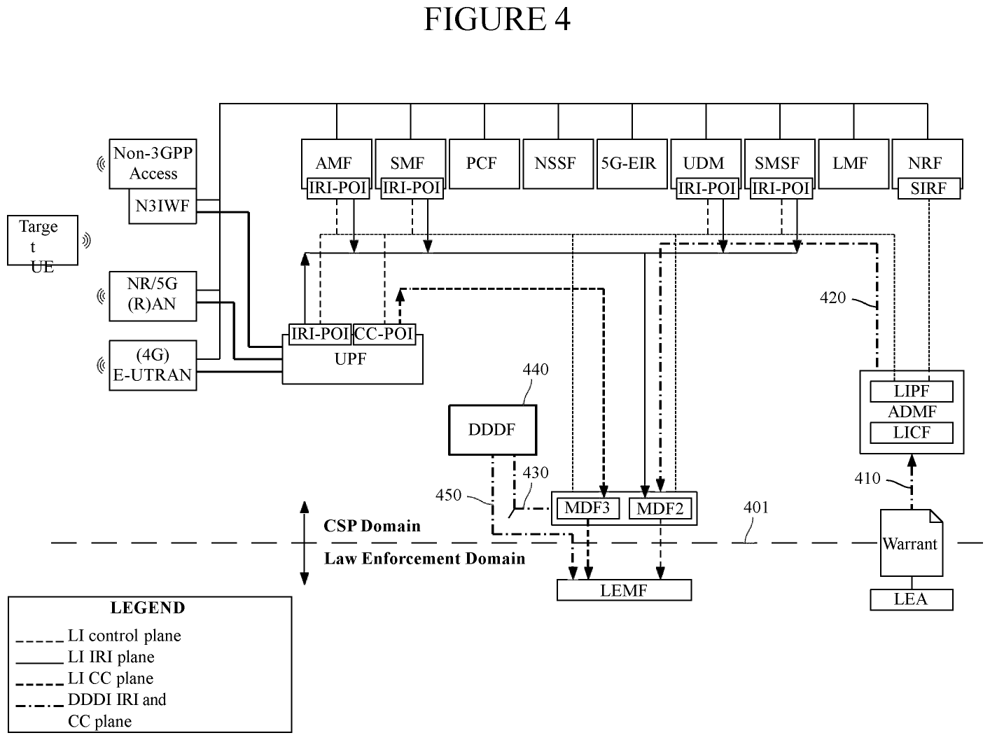

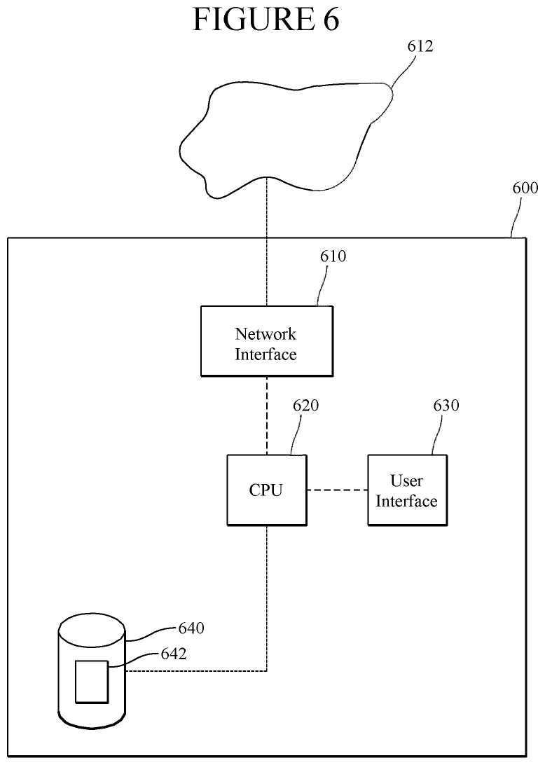

FIG. 4 illustrates DDDF in the 5G context according to an embodiment. This figure is based on FIGS. 6.2-2 in 3GPP TS 33 127 V16.7.0. The CSP domain is represented above line 401, while the LEA domain in represented below the line. Modified HI1 interface 410 is used to transmit parameters specifying the manner of activating DDDI delivery. Further, an additional X1 interface 420 is used to transmit these parameters to the MDFs. MDFs provide the LI data to DDDF 440 via an internal interface 430. DDDF 440 adds DDDI to the LI data before transmitting them to the LEMF via a modified HI 450. The significance of blocks and abbreviations in FIG. 4 that are known and easily found in TS 33 127 V16.7.0 are omitted if they are not necessary to describe DDDF and interfaces modified to provide DDDI.

DDDF may be configured and activated via the warrant, on LEA's demand. LEA may further customize DDDF in order to be compliant with local regulations or to receive other information (DDDI parameters) useful for its investigative needs.

DDDF function may also be activated via a global property affecting all warrants. When activated on warrant base by HI1, the administration function, ADMF, acts according to X1-related clause 4.1.4 of ETSI TS 103 221-1 V1.7.1 entitled “Lawful Interception (LI); Internal Network Interfaces; Part 1: X1” (made public in August 2020) to notify directly DF to activate DDDF at LIID level.

DDDF's activation may be implemented based on the standard procedures of the TS 103.120 at a CREATE Request from LEMF (see V1.8.1 entitled “Lawful Interception (LI); Interface for warrant information” made public in March 2021) by extending the HI-1 Object definition (see clause 7.1) in a backward-compatible way. Specifically, the field TaskDeliveryDetails (see clause 8.2.8) may be extended in the DeliveryProfile field of the DeliveryDestination by including a new set of Buffering activation details. Such new warrant data is notified on X1 by ADMF toward MF to inform HM.

When LEA requests to create (or modify) a task on HI1 with buffered delivery on HI, CSP (specifically) ADMF additionally interacts with the MF/DF via an X1 interface (see e.g., 420 in FIG. 4) to notify that for such a request (identified by XID for identified targets) a specific new buffered delivery type has to be applied. This new parameter may be added to the currently defined X1 standard parameter values to maintain the backward compatibility.

Once DDDF has been activated and HM intercepts LI data, DF is in charge with promptly forwarding LI data to LEMF. In case of a link outage toward the LEA, DDDF buffers LI data and starts a counter to measure delay time. Once the link is restored, DDDF stops the counter and calculates the time of effective delivery toward the LEA. The counter time is copied in the “delayofdelivery” parameter and the system time is copied in the “timeofdelivery” parameter.

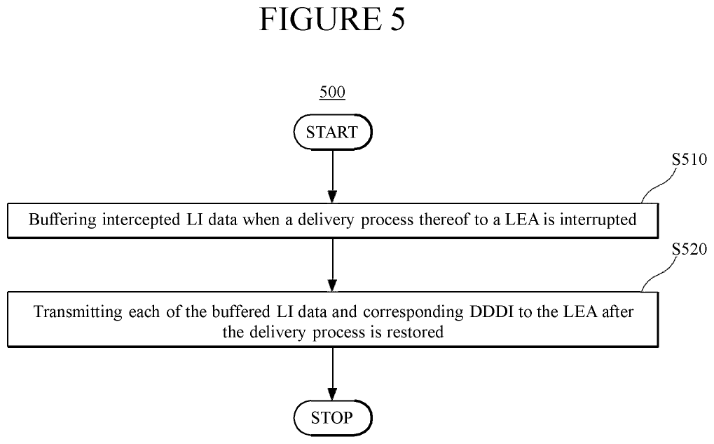

FIG. 5 is a flowchart of a method (500) according to an embodiment. Method 500, which is performed by a CSP executing LI, includes buffering intercepted LI data if a delivery process thereof to an LEA is interrupted at S510. The method further includes transmitting each of the buffered LI data and corresponding delayed data delivery information, DDDI, to the LEA after the delivery process is restored at S520. The DDDI may include a first parameter that specifies an amount of delay caused by the delivery process being interrupted and/or a second parameter that specifies a time of when the respective LI data is transmitted. DDDI may be provided (i.e., the parameter values changed from default values) after a predetermined amount of delay of the delivery process occurs, when an amount of delay of the delivery process exceeds a time interval between two successive LI data interceptions of the LI task, or if LEA requested when initiating or modifying the LI task.

FIG. 6 is a block diagram of a network device 600 of a CSP performing LI. Network device 600 has a network interface 610, a data processing unit 620 and a memory 640. These components cooperatively operate to buffer intercepted LI data if a delivery process of the intercepted LI data to an LEA 612 is interrupted, and to transmit each of the buffered LI data and corresponding DDDI to the LEA 612 after the delivery process is restored.

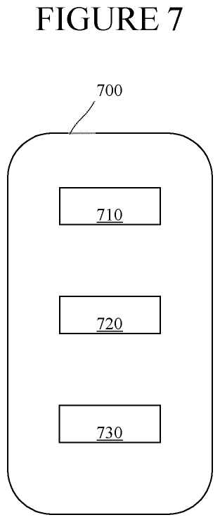

FIG. 7 is a schematic representation of a network device 700 of a CSP performing LI. Network device 700 has a communication module 710, a data storage module 720 and a DDDI module 730. Communication module 710 delivers intercepted LI data to LEA. Data storage module 720 stores the intercepted LI data if a delivery of the intercepted LI data to LEA is interrupted. DDDI module 730 provides DDDI to be delivered with each of the buffered intercepted LI data when the delivery is restored.

For a CSP (network operator), the use of a DDDF-type approach provides a comprehensive solution for an LEA's request for delay-related information acquired in view of further investigative activities. This DDDF-type approach can be integrated in 4G, 5G and other networks (with or without cloud implementation) coexisting with current LI architecture and functionality. This approach is flexible, enabling compliance with regulations and customer needs.

By using DDDF, LEAs have access to delay-related information not available (collected) previously. There is increasing urgency (observed in several countries) to better know and control such delays. A significant advantage of the proposed embodiments is the backward compatibility.

The disclosed embodiments provide methods and devices that supply delay data delivery information to a law enforcement agency. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

As also will be appreciated by one skilled in the art, the embodiments may take the form of an entirely hardware embodiment or an embodiment combining hardware and software aspects. Further, the embodiments, e.g., the configurations and other logic associated with the charging process to include embodiments described herein, such as the methods associated with FIGS. 3 and 5 may take the form of a computer program product such as 642 stored on a computer-readable storage medium such as 640 having computer-readable instructions embodied in the medium. Any suitable computer-readable storage medium may be utilized, including hard disks, CD-ROMs, digital versatile disc (DVD), optical storage devices, or magnetic storage devices such as floppy disk or magnetic tape. Other non-limiting examples of computer-readable media include flash-type memories or other known memories.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1-25. (canceled)

26. A method performed in a communication service provider (CSP) domain in which a lawful interception (LI) is executed, the method comprising:
buffering intercepted LI data when a delivery process for transmitting the intercepted LI data to a law enforcement agency (LEA) is interrupted; and
transmitting each of the buffered LI data with corresponding delayed data delivery information (DDDI) to the LEA after the delivery process is restored, wherein the DDDI includes a first parameter that specifies an amount of delay caused by the delivery process being interrupted.

27. The method of claim 26, wherein the DDDI includes a second parameter that specifies a time of when the respective LI data is transmitted.

28. The method of claim 26, further comprising:
providing the DDDI after a predetermined amount of delay of the delivery process occurs.

29. The method of claim 26, further comprising:
providing the DDDI when an amount of delay of the delivery process exceeds a time interval between two successive LI data interceptions of a same LI task.

30. The method of claim 26, further comprising:
providing the DDDI based on LEA's request when initiating or modifying an LI task.

31. The method of claim 26, wherein the DDDI is set to one or more default values when the delivery process proceeds uninterrupted and there is no buffered LI data.

32. The method of claim 26, wherein the CSP is a 5G system.

33. A network device of a communication service provider (CSP) performing lawful interception (LI) the network device comprising a network interface, a data processing unit and a memory cooperatively operating:
to buffer intercepted LI data when a delivery process transmitting the intercepted LI data to a law enforcement agency (LEA) is interrupted; and
to transmit each of the buffered LI data with corresponding data delivery delay information (DDDI) to the LEA after the delivery process is restored, wherein the DDDI includes a first parameter that specifies an amount of delay caused by the delivery process being interrupted.

34. The network device of claim 33, wherein the DDDI includes a second parameter that specifies a time of the respective LI data is transmitted.

35. The network device of claim 33, wherein the DDDI is provided after a predetermined amount of delay of the delivery process occurs.

36. The network device of claim 33, wherein the DDDI is provided when an amount of delay of the delivery process exceeds a time interval between two successive LI data interceptions of a same LI task.

37. The network device of claim 33, wherein the DDDI is provided based on LEA's request when initiating or modifying an LI task.

38. The network device of claim 33, wherein the DDDI is set to one or more default values when the delivery process proceeds uninterrupted and there is no buffered LI data.

39. The network device of claim 33, wherein the CSP is a 5G system.

40. A non-transitory computer readable storage medium storing executable code, which, when executed by a computer of a communication service provider (CSP) performing lawful interception (LI) configures the computer perform the method of claim 1.
